(19) United States
(12) Patent Application Publication
(10) Pub. No.: US 2009/0288889 A1
(43) Pub. Date: Nov. 26, 2009

(54) PROXIMITY SENSOR DEVICE AND METHOD WITH SWIPETHROUGH DATA ENTRY

(75) Inventors: Ola CARLVIK, Wayne, PA (US); Lilli Ing-Marie JONSSON, Los Gatos, CA (US)

Correspondence Address: INGRASSIA FISHER & LORENZ, P.C. (SYNA), 7010 E. Cochise Road, SCOTTSDALE, AZ, 85253, US

(73) Assignee: SYNAPTICS INCORPORATED, Santa Clara, CA (US)

(21) Appl. No.: 12/126,807

(22) Filed: May 23, 2008

(51) Int. Cl. G06F 3/041

(52) U.S. Cl. 178/18.03

(57) ABSTRACT

A touch sensor device and method is provided that facilitates improved device usability. Specifically, the touch screen device and method provide user interface functionality while reducing the possibility of inadvertent activation of certain functions. The touch screen device comprises a proximity sensor adapted to detect object presence in a sensing region, a display screen overlapping the sensing region, and a processing system. The touch screen device is adapted to provide user interface functionality by facilitating the display of user interface elements and the selection and activation of corresponding functions. For certain functions, the touch screen device and method uses the presence of a second object to confirm selection of a function before that function will be performed. So configured, the touch device screen is able to reduce the likelihood of inadvertent activation for certain functions on the device.

### FIELD OF THE INVENTION

This invention generally relates to electronic system, and more specifically relates to proximity sensor devices and using a proximity sensor device for producing user interface inputs.

### BACKGROUND OF THE INVENTION

Proximity sensor devices (also commonly called touch sensor devices) are widely used in a variety of electronic systems. A proximity sensor device typically includes a sensing region, often demarked by a surface, in which input objects can be detected. Example input objects include fingers, styli, and the like. The proximity sensor device can utilize one or more sensors based on capacitive, resistive, inductive, optical, acoustic and/or other technology. Further, the proximity sensor device may determine the presence, location and/or motion of a single input object in the sensing region, or of multiple input objects simultaneously in the sensing region.

The proximity sensor device can be used to enable control of the associated electronic system. For example, proximity sensor devices are often used as input devices for larger computing systems, including: notebook computers and desktop computers. Proximity sensor devices are also often used in smaller systems, including: handheld systems such as personal digital assistants (PDAs), remote controls, and communication systems such as wireless telephones and text messaging systems. Increasingly, proximity sensor devices are also used in media systems, such as CD, DVD, MP3, video or other media recorders or players. The proximity sensor device can be integral or peripheral to the computing system with which it interacts.

One common application for a proximity sensor device is in a touch screen. In a touch screen, the proximity sensor is combined with a display screen for displaying graphical and/or textual elements. Together, the proximity sensor and display screen function to provide a user interface. In these applications the proximity sensor device can function as a value adjustment device, cursor control device, selection device, scrolling device, graphics/character/handwriting input device, menu navigation device, gaming input device, button input device, keyboard and/or other input device.

One issue with some past proximity sensor devices is the need to provide flexible data entry capability in limited space. For example, on many mobile phones, the available space on each phone for a proximity sensor device is extremely limited. In these types of sensor devices, it can be very difficult to provide a full range of input options to users with effective ease of use. For example, relatively complex and precise gestures have been required for many types of input, thus causing data entry and other user input to be difficult and overly time consuming.

Thus, there exists a need for improvements in proximity sensor device usability that facilitates the proximity sensor devices in a wide variety of devices, including handheld devices.

### BRIEF SUMMARY OF THE INVENTION

The embodiments of the present invention provide a device and method that facilitates improved device usability. Specifically, the device and method provide improved user interface functionality by facilitating quick and easy data entry using proximity sensor devices with limited input space. The electronic system includes a processing system and a sensor adapted to detect strokes in a sensing region. The device is adapted to provide user interface functionality by facilitating data entry responsive to a marker crossed by a stroke and a direction of the stroke. Specifically, in accordance with an embodiment of the invention, the processing system is configured to define a plurality of markers in the sensing region. The processing system is further configured to produce an output responsive to the sensor detecting a stroke that meets a set of criteria. The produced output corresponds to a selected option, and the option is selected from a plurality of options based on a marker crossed by the stroke and a direction of the stroke. By so defining a plurality of marker, and facilitating the selection of options based on a marker crossed by a stroke and the direction of the stroke, the electronic system facilitates fast and flexible user input in a limited space.

The method is implemented to improve user interface functionality by facilitating data entry using a proximity sensor device. The method includes the steps of defining a plurality of markers in the sensing region of the sensor and detecting strokes in the sensing region. The method produces an output responsive to detecting a stroke that meets a set of criteria. The produced output corresponds to a selected option, and the option is selected from a plurality of options based on a marker crossed by the stroke and a direction of the stroke. By so defining a plurality of marker, and facilitating the selection of options based on a marker crossed by a stroke and the direction of the stroke, the method facilitates fast and flexible user input in a limited space.

### BRIEF DESCRIPTION OF DRAWINGS

The preferred exemplary embodiment of the present invention will hereinafter be described in conjunction with the appended drawings, where like designations denote like elements, and:

FIG. 1 is a block diagram of an exemplary system that includes a proximity sensor device in accordance with an embodiment of the invention;

FIG. 2 is a flow diagram of a method for activating a function in accordance with the embodiments of the invention; and

FIG. 3-12 are top views of electronic system with proximity sensor devices in accordance with embodiments of the invention.

### DETAILED DESCRIPTION OF THE INVENTION

The following detailed description is merely exemplary in nature and is not intended to limit the invention or the application and uses of the invention. Furthermore, there is no intention to be bound by any expressed or implied theory presented in the preceding technical field, background, brief summary or the following detailed description.

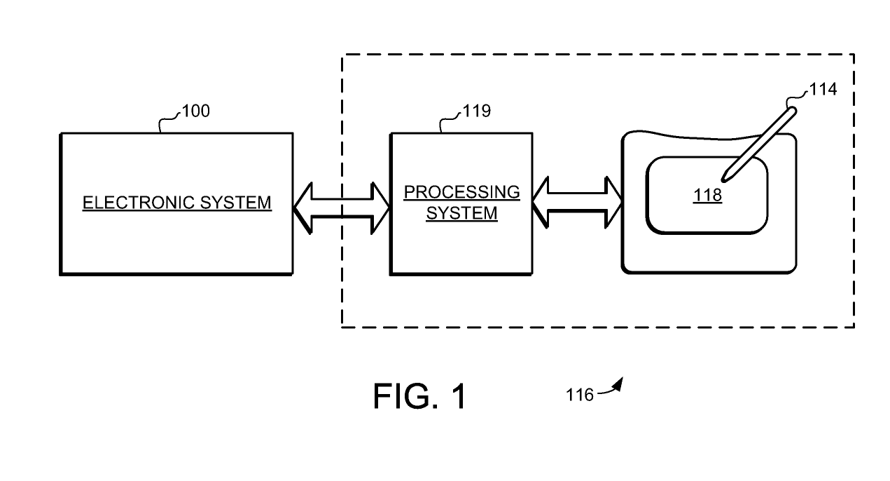

The embodiments of the present invention provide an electronic system and method that facilitates improved device usability. Specifically, the device and method provide improved user interface functionality by facilitating quick and easy data entry using proximity sensors with limited space. Turning now to the drawing figures, FIG. 1 is a block diagram of an exemplary electronic system 100 that operates with a proximity sensor device 116. As will be discussed in greater detail below, the proximity sensor device 116 can be implemented to function as an interface for the electronic system 100. Electronic system 100 is meant to represent any type of stationary or portable computer, including workstations, personal digital assistants (PDAs), video game players, communication devices (e.g., wireless phones and messaging devices), media device recorders and players (e.g., televisions, cable boxes, music players, and video players), digital cameras, video cameras, and other devices capable of accepting input from a user and of processing information. Accordingly, the various embodiments of system 100 may include any type of processing system, memory or display. Additionally, the elements of system 100 may communicate via any combination of protocols and connections, including buses, networks, or other wired or wireless interconnections. Non-limiting examples of these include I2C, SPI, PS/2, Universal Serial Bus (USB), Bluetooth, RF, IRDA.

The proximity sensor device 116 has a sensing region 118 and is implemented with a processing system 119. The proximity sensor device 116 is sensitive to positional input, such as the position or motion of one or more input objects within the sensing region 118. A stylus 114 is shown in FIG. 1 as an exemplary input object, and other examples include a finger (not shown). “Sensing region” 118 as used herein is intended to broadly encompass any space above, around, in, or near the proximity sensor device 116 where the sensor is able to detect an input object. In a conventional embodiment, sensing region 118 extends from a surface of the proximity sensor device 116 in one or more directions into space until the noise and decreased signal prevent accurate object detection. This distance may be on the order of less than a millimeter, millimeters, centimeters, or more, and may vary significantly with the type of position sensing technology used and the accuracy desired. Embodiments of the proximity sensor device 116 may require contact with a surface, either with or without applied pressure. Accordingly, the planarity, size, shape and exact locations of particular sensing regions 118 can vary widely from embodiment to embodiment.

Taking capacitive proximity sensors as an example, sensing regions with rectangular projected shape are common, and many other shapes are possible. For example, depending on the design of the sensor array and surrounding circuitry, shielding from any input objects, and the like, sensing regions 118 can be made to have two-dimensional projections of other shapes. Similar approaches can be used to define the three-dimensional shape of the sensing region. For example, any combination of sensor design, shielding, signal manipulation, and the like can effectively define a sensing region that extends a short or a long distance in the third dimension (into out of the page) in FIG. 1. With a sensing region that extends almost no distance from an associated surface of the proximity sensor device, input may be recognized and acted upon only when there is physical contact between any input objects and the associated surface. Alternatively, the sensing region may be made to extend a long distance, such that an input object positioned some distance away from a defined surface of proximity sensor device may still be recognized and acted upon. Therefore, interaction with a proximity sensor device may be either through contact or through non-contact proximity.

In operation, the proximity sensor device 116 suitably detects positional information of one or more input objects within sensing region 118, and uses any number of techniques and structures to do so. As several non-limiting examples, the proximity sensor device 116 can use capacitive, resistive, inductive, optical, acoustic, or other techniques either alone or in combination. These techniques are advantageous to ones requiring moving mechanical structures (e.g. mechanical switches) that more easily wear out over time. In a common capacitive implementation of the proximity sensor device, a voltage or current is applied to create an electric field about a surface. A capacitive proximity sensor device would then detect positional information by detecting changes in capacitance reflective of the changes in the electric field due to the object. In a common resistive implementation, a flexible first substrate and a rigid second substrate carry uniform conductive layers that face each other. The conductive layers are separated by one or more spacers, and a voltage gradient is created across the layers during operation. Pressing the flexible first substrate causes electrical contact between the conductive layer on the first substrate and the conductive layer on the second substrate. The resistive proximity sensor device would then detect positional information about the object by detecting the voltage output. In a common inductive implementation, one or more sensor coils pick up loop currents induced by one or more resonating coils. The inductive proximity sensor device then uses the magnitude, phase, or frequency, either alone or in combination, to determine positional information. Examples of technologies that can be used to implement the various embodiments of this invention can be found at U.S. Pat. No. 5,543,591, U.S. Pat. No. 5,815,091, and U.S. Pat. No. 6,259,234, each assigned to Synaptics Inc.

The proximity sensor device 116 can include one or more sensing regions 118 supported by any appropriate proximity sensing technology. For example, the proximity sensor device 116 can use arrays of capacitive sensor electrodes to support any number of sensing regions 118. As another example, the proximity sensor device 116 can use capacitive sensing technology in combination with resistive sensing technology to support the same sensing region 118 or to support separate sensing regions 118.

The processing system 119 is coupled to the proximity sensor device 116 and the electronic system 100. The processing system 119 can perform a variety of processes on the signals received from the sensor to implement the proximity sensor device 116. For example, the processing system 119 can select or connect individual sensor electrodes, detect presence/proximity, calculate position or motion information, or interpret object motion as gestures.

In some embodiments, the proximity sensor device 116 uses processing system 119 to provide electronic indicia of positional information to the electronic system 100. The system 100 appropriately processes the indicia to accept inputs from the user, to move a cursor or other object on a display, or for any other purpose. With such embodiments, processing system 119 can report positional information to electronic system 100 constantly, when a threshold is reached, or in response some criterion such as an identified stroke of object motion. In other embodiments, the processing system directly processes the indicia to accept inputs from the user, to move a cursor or other object on a display, or for any other purpose based on any number and variety of criteria.

In accordance with embodiments of the invention, the processing system 119 can define a plurality of markers in the sensing region, and can determine the direction of these strokes as well as when strokes of object motion cross the markers. Additionally, in various embodiments, the processing system 119 is configured to provide user interface functionality by facilitating data entry responsive to a marker crossed by a stroke and a direction of the stroke. Specifically, processing system 119 is configured to produce an output responsive to the sensor detecting a stroke that meets a set of criteria. The produced output corresponds to a selected option, and the option is selected from a plurality of options based on a marker crossed by the stroke and a direction of the stroke.

In this specification, the term “processing system” includes any number of processing elements appropriate to perform the recited operations. Thus, the processing system 119 can comprise any number of discrete components, any number of integrated circuits, firmware code, and/or software code—whatever is needed to perform the recited operations. In some embodiments, all processing elements that comprise the processing system 119 are located together, in or near the proximity sensor device 116. In other embodiments, these elements would be physically separated, with some elements of the processing system 119 close to a sensor of sensor device 116, and some elsewhere (such as near other circuitry for the electronic system 100). In this latter embodiment, minimal processing could be performed by the elements near the sensor, and the majority of the processing could be performed by the elements elsewhere.

Furthermore, the processing system 119 can communicate with some part of the electronic system 100, and be physically separate from or physically integrated with that part of the electronic system. For example, the processing system 119 can reside at least partially on a microprocessor for performing functions for the electronic system 100 aside from implementing the proximity sensor device 116.

As used in this application, the term “electronic system” broadly refers to any type of device that operates with proximity sensor device 116. The electronic system 100 could thus comprise any type of device or devices in which a proximity sensor device 116 can be implemented in or coupled to. The proximity sensor device 116 thus could be implemented as part of the electronic system 100, or coupled to the electronic system 100 using any suitable technique. As non-limiting examples, the electronic system 100 could thus comprise any type of computing device listed above or another input device (such as a physical keypad or another touch sensor device). In some cases, the electronic system 100 is itself a peripheral to a larger system. For example, the electronic system 100 could be a data input device such as a remote control, or a data output device such as a display system, that communicates with a computing system using a suitable wired or wireless technique. It should also be noted that the various elements (any processors, memory, etc.) of the electronic system 100 could be implemented as part of the proximity sensor device 116, as part of a larger system, or as a combination thereof. Additionally, the electronic system 100 could be a host or a slave to the proximity sensor device 116.

In some embodiments the proximity sensor device 116 is implemented with buttons or other input devices near the sensing region 118. The buttons can be implemented to provide additional input functionality to the proximity sensor device 116. For example, the buttons can be used to facilitate selection of items using the proximity sensor device. Of course, this is just one example of how additional input functionality can be added to the proximity sensor device 116, and in other implementations the proximity sensor device 116 could include alternate or additional input devices, such as physical or virtual switches, or additional proximity sensing regions. Conversely, the proximity sensor device 116 can be implemented with no additional input devices.

Likewise, the positional information determined the processing system 119 can be any suitable indicia of object presence. For example, the processing system 119 can be implemented to determine “zero-dimensional” 1-bit positional information (e.g., near/far or contact/no contact) or “one-dimensional” positional information as a scalar (e.g., position or motion along a sensing region). Processing system 119 can also be implemented to determine multi-dimensional positional information as a combination of values (e.g., two-dimensional horizontal/vertical axes, three-dimensional horizontal/vertical/depth axes, angular/radial axes, or any other combination of axes that span multiple dimensions), and the like. Processing system 119 can also be implemented to determine information about time or history.

Furthermore, the term “positional information” as used herein is intended to broadly encompass absolute and relative position-type information, and also other types of spatial-domain information such as velocity, acceleration, and the like, including measurement of motion in one or more directions. Various forms of positional information may also include time history components, as in the case of gesture recognition and the like. As will be described in greater detail below, the positional information from the processing system 119 facilitates a full range of interface inputs.

In some embodiments, the proximity sensor device 116 is adapted as part of a touch screen interface. Specifically, the proximity sensor device is combined with a display screen that is overlapped by at least a portion of the sensing region 118. Together, the proximity sensor device 116 and the display screen provide a touch screen for interfacing with the electronic system 100. The display screen can be any type of electronic display capable of displaying a visual interface to a user, and can include any type of LED (including organic LED (OLED)), CRT, LCD, plasma, EL or other display technology. When so implemented, the proximity sensor device 116 can be used to activate functions on the electronic system 100, such as by allowing a user to select a function by placing an input object in the sensing region proximate an icon or other user interface element that is associated with or otherwise identifies the function. The user's placement of the object can thus identify the function to the electronic system 100. Likewise, the proximity sensor device 116 can be used to facilitate user interface interactions, such as button functions, scrolling, panning, menu navigation, cursor control, and the like. As another example, the proximity sensor device can be used to facilitate value adjustments, such as by enabling changes to a device parameter. Device parameters can include visual parameters such as color, hue, brightness, and contrast, auditory parameters such as volume, pitch, and intensity, operation parameters such as speed and amplification. In these examples, the proximity sensor device is used to both activate the function and then to perform the adjustment, typically through the use of object motion in the sensing region 118.

It should also be understood that the different parts of the overall device can share physical elements extensively. For example, some display and proximity sensing technologies can utilize the same electrical components for displaying and sensing. One implementation can use an optical sensor array embedded in the TFT structure of LCDs to enable optical proximity sensing through the top glass of the LCDs. Another implementation can use a resistive touch-sensitive mechanical switch into the pixel to enable both display and sensing to be performed by substantially the same structures.

It should also be understood that while the embodiments of the invention are to be described herein the context of a fully functioning proximity sensor device, the mechanisms of the present invention are capable of being distributed as a program product in a variety of forms. For example, the mechanisms of the present invention can be implemented and distributed as a proximity sensor program on a computer-readable signal bearing media. Additionally, the embodiments of the present invention apply equally regardless of the particular type of computer-readable signal bearing media used to carry out the distribution. Examples of signal bearing media include: recordable media such as memory sticks/cards/modules and disk drives, which may use flash, optical, magnetic, holographic, or any other storage technology.

In the embodiments of the present invention, the proximity sensor device 116 provides improved user interface functionality by facilitating quick and easy data entry using proximity sensors with limited space. Specifically, the proximity sensor device 116 is adapted to provide user interface functionality by facilitating data entry responsive to a marker crossed by a stroke and a direction of the stroke. To facilitate this, the processing system 119 configured to define a plurality of markers in the sensing region 118. The processing system 119 is further configured to produce an output responsive to the sensor detecting a stroke that meets a set of criteria. The produced output corresponds to a selected option, and the option is selected from a plurality of options based on a markers crossed by the stroke and a direction of the stroke. By so defining a plurality of marker, and facilitating the selection of options based on a marker crossed by a stroke and the direction of the stroke, the proximity sensor device 116 facilitates fast and flexible user input in a limited space.

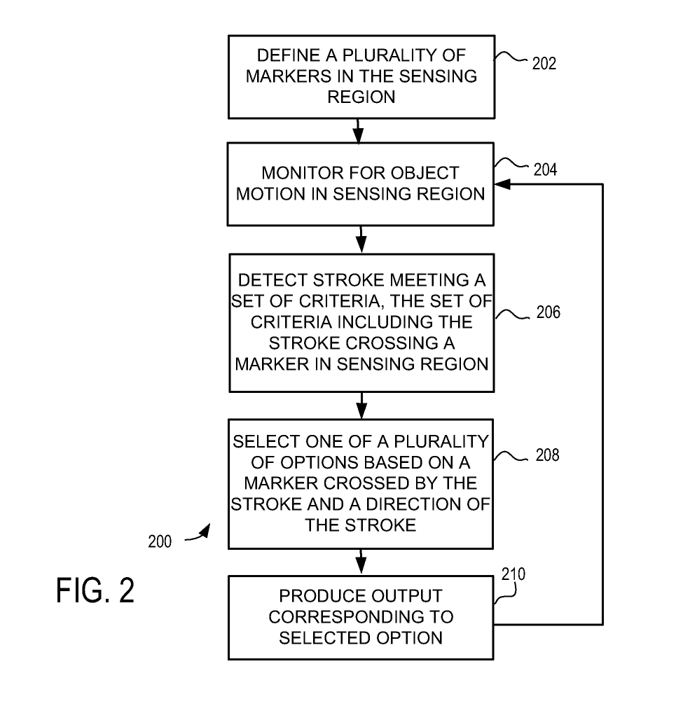

Turning now to FIG. 2, a method 200 of producing an output using a proximity sensor device is illustrated. Alternate embodiments of the method can flow differently from what is illustrated in FIG. 2 and described below. For example, other embodiments may have different order of steps and different loops. In general, the method provides improved user interface functionality by facilitating quick and easy data entry on proximity sensors with limited space. For example, the method allows a user to produce a variety of different outputs using a proximity sensor with relatively simple, easy to perform strokes in the sensing region. In such a system the proximity sensor provides a plurality of different outputs that can be produced with a corresponding stroke of object motion. Thus, a user can initiate a desired output with a stroke in a particular location and direction. In one specific example that will be described below, the method 200 is used to facilitate character entry into a device by enabling the various characters to be produced in response to strokes in various locations and directions in the sensing region.

The first step 202 of method 200 is to define a plurality of markers in the sensing region. In general, the markers are simply defined locations in the sensing region for which an object crossing instigates a specified action. The size, shape and location of the markers would typically depend on the specific application. In one specific embodiment, the markers correspond to boundaries between subregions in the sensing region. This embodiment will be described in greater detail below. In other embodiments, the markers reside in other locations in the subregions, or do not have any particular relationship between any subregions of the sensor.

The second step 204 is to monitor for object presence in the sensing region of a proximity sensor device. Again, the proximity sensor device can comprise any type of suitable device, using any type of suitable sensing technology. Typically, the step of monitoring for object presence would be performed continuously, with the proximity sensor device continuously monitoring for object presence whenever it is enabled.

The next step 206 is to detect a stroke of object motion meeting a set of criteria, where the set of criteria includes the stroke crossing a marker in the sensing region. In general, a stroke is defined as a detected instance of object crossing at least a portion of the sensing region. For example, when a user swipes a finger across the surface of a sensor, the detected instance of object motion is a stroke that can be detected by the sensor. It should be noted that location of the beginning and ending of a stroke will not matter in most embodiments. However, in some cases that will be discussed below it can be used to determine the direction and/or length of the stroke. In such cases, the beginning and ending of the stroke can be determined when the object enters and exits of the sensing region, or in any other suitable manner.

Likewise, the set of criteria are the criterion that the stroke should meet to produce a response that corresponds to an associated input option. In the method 200, the set of criteria includes at least one criterion, i.e., the criterion that the stroke crosses at least one marker in the sensing region. As will be described in greater detail down below, other criterion can also be included. For example, other criterion in the set of criteria can include requirements for the length of the detected stroke, the angle of the detected, the speed of the detected stroke, etc.

Thus, in step 206, a stroke is detected that meets a set of criteria, where that set includes the criterion of the stroke crossing a marker in the sensing region, and can include other criteria as well.

The next step 208 is to select one of the plurality of options based on a marker crossed by a stroke, and a direction of the stroke. In general, the proximity sensor device is implemented such that various input options correspond to various marker and direction combinations. Thus, when a particular marker is crossed with a stroke having a particular direction, a corresponding option is selected. If another stroke crosses the same marker, but has a different direction, then a different corresponding option is selected. Thus, a large number of options can be selected by a user with a stroke crossing an appropriate marker and having an appropriate direction.

As will be described in greater detail below, step 208 can be implemented in a variety of different ways. For example, step 208 can be implemented to select an option that corresponds to the last marker crossed by a stroke. Likewise, step 208 can be implemented to select an option that corresponds to the first marker crossed by the stroke. Both of these implementations function to determine the appropriate option when more than one marker is crossed by the stroke. Additionally, step 208 can be implemented to select an option that corresponds to a subregion that is entered or exited by the stroke crossing a marker.

Likewise, with regard to the direction of the stroke, step 208 can again be implemented in a variety of different ways. For example, step 208 can be implemented to select an option that corresponds to the direction of the stroke at the point the stroke crosses the marker. Likewise, step 208 can be implemented to select an option that corresponds to an average direction or a predominant direction of the stroke. Furthermore, it should be noted that selecting an option based on the direction of the stroke does not require that the actual direction be calculated with any precision. For example, it can be implemented such that motion within a large range of direction qualifies as a direction corresponding to a particular input option. Thus, a stroke crossing from left to right generally (such as within a 45 degree range of horizontal) could be considered a first direction resulting in one input option being selected. Conversely, a stroke crossing from right to left generally (such as within a 45 degree range of horizontal) could be considered the second direction resulting in another input option being selected.

Likewise, a stroke crossing from top to bottom generally (such as within a 45 degree range of vertical) could be considered a third direction resulting in a third input option being selected. Conversely, a stroke crossing from bottom to top generally (such as within a 45 degree range of vertical) could be considered the fourth direction resulting in a fourth option being selected.

In all these cases an input option is selected based on both a marker crossed by stroke and a direction of the stroke. The next step 210 is to produce an output corresponding to a selected option. The method 200 can be implemented to facilitate many different types of outputs. As mentioned above, it can be implemented to facilitate character entry, such as text, numbers and symbols. In such an implementation, step 210 would produce the character corresponding to marker crossed and the direction of the stroke. In some other implementations, step 210 would produce user interface outputs, such as scrolling, panning, menu navigation, cursor control, and the like. In some other implementations, step 210 would produce value adjustments, such as changing a device parameter, including visual parameters such as color, hue, brightness, and contrast, auditory parameters such as volume, pitch, and intensity, operation parameters such as speed and amplification.

With the option selected and the appropriate output produced, the method 200 returns to step 204 and continues to monitor for object motion in the sensing region. Thus, the method 200 provides the ability for user to produce a variety of different outputs using a proximity sensor based on markers crossed and the direction of the strokes. Thus, relatively simple, easy to perform strokes in the sensing region can be utilized to provide a plurality of different outputs.

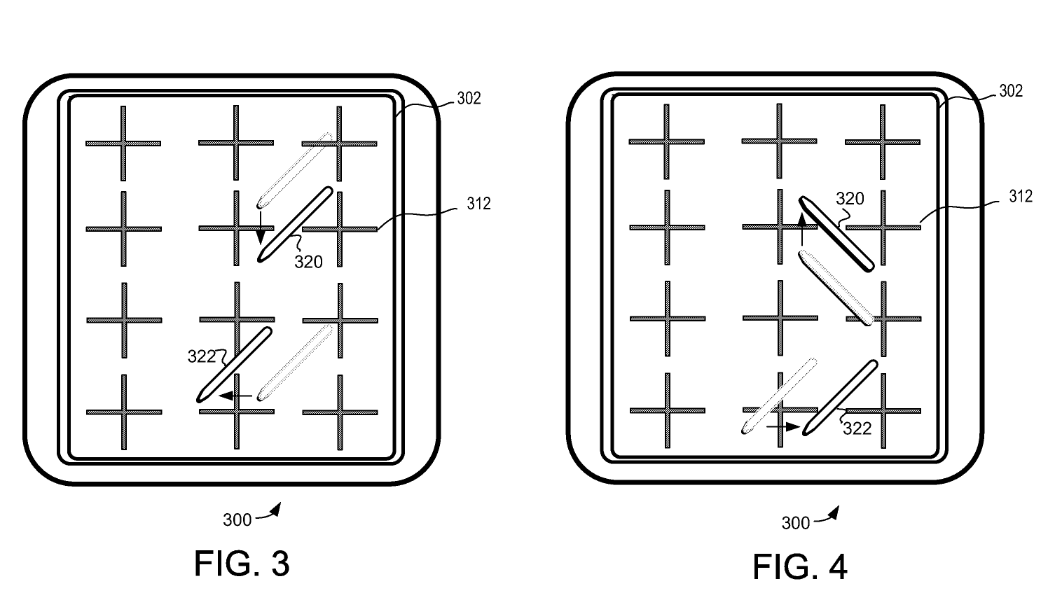

Turning now to FIGS. 3-10, various embodiments of exemplary electronic systems are illustrated. The illustrated embodiments are a handheld device that uses a proximity sensor as a user interface. Of course, this is just one simplified example of the type of device and implementation that can be provided. Turning now specifically to FIGS. 3 and 4, a device 300 that includes a proximity sensor adapted to sensing object motion in a sensing region 302 is illustrated. Also illustrated in the sensing region 302 is a set of 12 markers 312. Each of these markers comprises a defined location in the sensing region, where object motion crossing instigates a specified action. In this illustrated embodiments, each of the markers 312 has a “plus” shape. Again, this is just one example of the many possible shapes and arrangements of markers in the sensing region. It should also be noted that while the illustrated markers 312 have a noticeable thickness in each of their four segments, that this is not required for implementation. In fact, in most embodiments the width of the markers would be negligible, as crossing any defined point location can be considered crossing a marker. Similarly, while the illustrated markers 312 have particular gaps between markers, no specific gap distance is required for implementation, and smaller or larger gaps can be accommodated. The markers can even overlap, such as when other criteria are used to disambiguate which marker is used to define the input selection when multiple markers overlap in space and are cross. Further, the makers can change in size and shape during operation in some implementations.

Also illustrated in FIG. 3 is the motion of two objects, pen 320 and 322, across the sensing region. Specifically, pen 320 is illustrated as traversing across a marker from top to bottom, while pen 322 is illustrated as traversing across another marker from right to left. Likewise, FIG. 4 illustrates the motion of the pens in different directions. Specifically, FIG. 4 illustrates the pen 320 traversing from bottom to top, while pen 322 is illustrated as traversing from left to right.

As described above, a proximity sensor device in accordance with the embodiments of the invention is implemented to produce an output responsive to the sensor detecting a stroke that meets a set of criteria, where the produced output corresponds to a selected option, and the option is selected from a plurality of options based on a marker crossed by the stroke and a direction of the stroke. Thus, FIGS. 3 and 4 illustrate how four different strokes could be used to produce four different outputs using the proximity sensor device and two of the defined markers. For example, the motion of pen 320 traversing from top to bottom as illustrated in FIG. 3 could be implemented to output a “J” character, while the motion of pen 320 traversing from bottom to top as illustrated in FIG. 4 could be implemented to output an “L” character. Likewise, the motion of pen 322 traversing from right to left as illustrated in FIG. 3 could be implemented to output a “+” symbol, while the motion of pen 322 traversing from right to left as illustrated in FIG. 4 could be implemented to output an “−” symbol.

Thus, by so defining the plurality of markers 312, and by facilitating the selection of options based on a marker crossed by a stroke and the direction of the stroke, the proximity sensor device facilitates fast and flexible user input in a limited space. For example, each of 12 markers illustrated could be implemented with four different options, each option corresponding to one of the four main directions of traversal across a marker. Thus, the proximity sensor device could be implemented to facilitate 48 different input options, with the user able to select and initiate the corresponding outputs with a relatively simple swipe across the corresponding marker and in a particular direction. Again, it should be emphasized that the “+” shape of the markers 312 is merely exemplary, and that other shapes could be used to provide four different input options. Furthermore, instead of using “+” shape markers with four input options, individual markers with less or more input options could be defined.

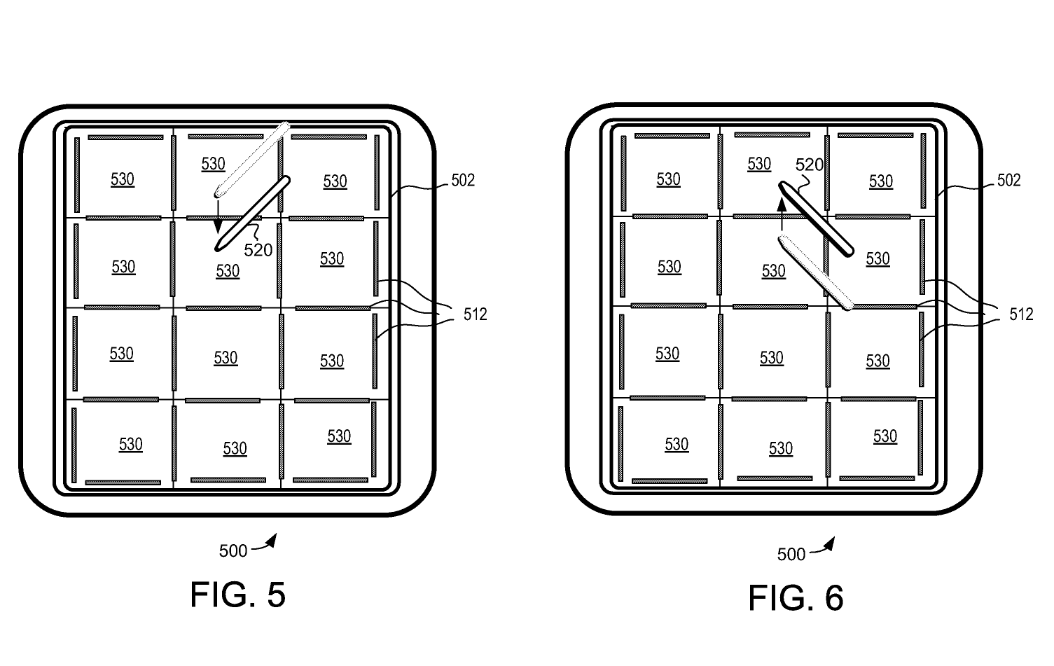

Turning now to FIGS. 5 and 6, another embodiment of a device 500 is illustrated. Device 500 again includes a proximity sensor device adapted to detect object motion in a sensing region 502. And like the previous embodiment, a plurality of markers 512 is defined in the sensing region 502. However, in this embodiment, each of the markers corresponds to a boundary of a subregion 530 in the sensing region 502. Specifically, there are 12 subregions 530 in the sensing region 502, with each of the markers 512 corresponding to a portion of the boundaries of the subregions. It should be noted that these subregions 530 can implemented as defined portions of the sensing region. Thus, the subregions 530 are not required correspond to any particular sensor electrode structure or arrangement. However, in some embodiments, the subregions 530 could be related to the underlying structure or layout of sensor electrodes in the proximity sensor device. For example, for some proximity sensor devices based on capacitive sensing technology, some or all of the markers can be made to align with one or more boundaries of single or groups of sensor electrodes. Conversely, for other proximity sensor devices based on capacitive sensing technology, there may be no boundaries aligned with the markers.

Again, each of the markers 512 is a defined location in the sensing region, where an object crossing instigates a specified action. It should again be noted that while the illustrated markers 512 have a noticeable thickness in each of their four segments, that this is not required for implementation. Additionally, while the illustrated markers 512 are shown as not meeting in the corners of the subregions 520, this is also not required and the abstract markers can touch such that there is no gap between them.

In contrast with the markers 312, the markers 512 have substantially one dimensional (linear) shape. In general, these types of markers are implemented to provide two input options that correspond to the main two directions (up/down or left/right) of a possible stroke crossing the marker (even though an infinite number of angular variations are available), as opposed to the four directions (up/down/left/right) available for each of the “+” shaped makers 312. These two directions are illustrated in FIGS. 5 and 6 as the motion of pen 520 brings it across part of the sensing region. Specifically, in FIG. 5, the pen 520 is illustrated as traversing across a marker from top to bottom, while in FIG. 6, the pen 520 is illustrated as traversing the same marker from bottom to top.

As described above, a proximity sensor device in accordance with the embodiments of the invention is implemented to produce an output responsive to the sensor detecting a stroke that meets a set of criteria, where the produced output corresponds to a selected option, and the option is selected from a plurality of options based on a marker crossed by the stroke and a direction of the stroke. Thus, FIGS. 5 and 6 illustrate how two different strokes could produce two different outputs using a defined marker. As there are 31 such markers in device 500, where each of the 31 markers is be implemented for two different options (one for each of the two main directions of traversal across the marker), the proximity sensor device could again be implemented to facilitate 62 different input options. The user of device 500 could thus select and initiate one of 62 corresponding outputs with a relatively simple swipe across the corresponding marker in a particular direction. Conversely, some directions associated with particular markers can lead to null as an input option.

When determining if a stroke crossed a marker, the sensor can be implemented to determine crossing based on modified determination of the path of the stroke. For example, the sensor can be implemented to average the direction of the actual path to determine if a marker has been crossed. Such an averaging can be accomplished by determining a linear vector from the beginning of the stroke to the end of the stroke. The marker crossed by the vector can then be used to select the appropriate input option. The use of the vector effectively averages and smooths the path, and is especially useful where the actual stroke is especially shaky or has large local deviations from what the actual intended path.

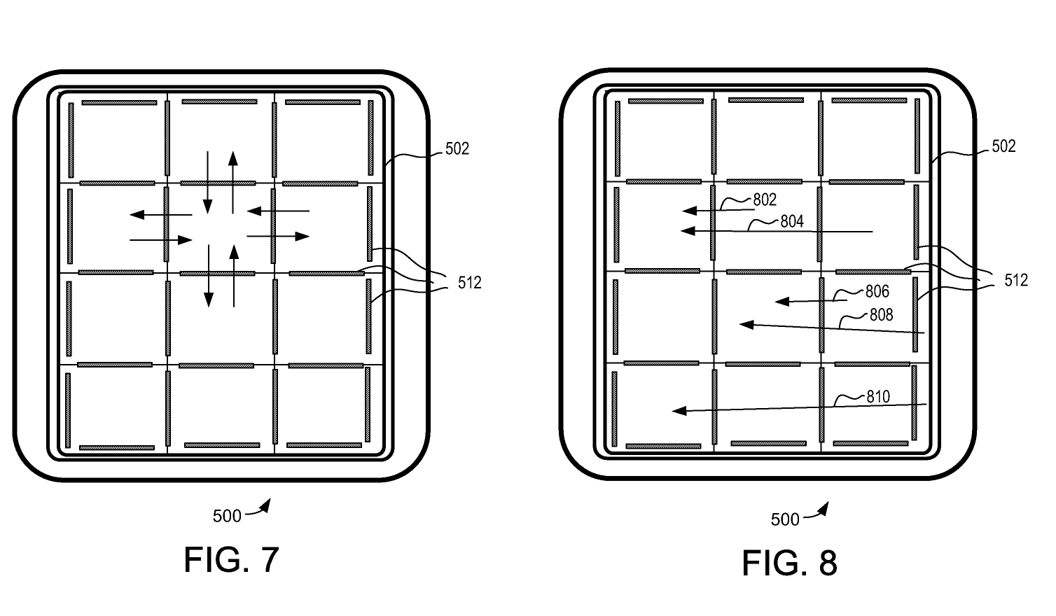

Turning now to FIG. 7, the device 500 is illustrated showing examples of various strokes in the sensing region 502. Specifically, FIG. 7 shows how the markers surrounding one subregion in the sensing region can be subject to 8 different strokes, with 2 strokes for each marker. Again, this illustrates that a large number of input options can be made available to a user in a limited space, and with relatively simple gestures required to active.

Turning now to FIG. 8, the device 500 is illustrated showing examples of various strokes in the sensing region 502. Specifically, FIG. 8 shows how strokes can traverse across different numbers of markers in the sensing region. In the case where a stroke crosses more than one marker, the system can be adapted to select the input option based any one of the crossed markers. For example, the system can be adapted to select an input option based on the last marker crossed by the stroke, or the first marker crossed by the stroke. Alternatively, the option could be selected based on a intermediate marker crossed where more than two markers are crossed by the stroke.

In a device where the input option is based on the last marker crossed by a stroke, strokes 802 and 804 would produce the same input option. Likewise, strokes 806 and 808 would produce the same input option. If however, the device were configured to select the input option based the first marker crossed, then strokes 802 and 804 would produce different input options, as 804 first crosses the marker on the right that crossed by stroke 802. Likewise with strokes 806 and 808. Stroke 801 crosses three markers. Thus, a system to could be implemented to select the input option based on the first marker, last marker, or any intermediate marker.

As will be described in greater detail below, whether a system is implemented to select an option based on the first maker, the last marker, or an intermediate marker can be largely an issue of device usability. In some devices users may find it more intuitive to use the device if the option is based on the first marker, while in other devices, or other users, may find it more intuitive if the option is based on the last marker.

Furthermore, the behavior of such devices from the perspective of the user is tied to user's perception of what input options are associated with each marker, as well as which marker (e.g., first, last) is used to determine the input option. As will be described in greater detail below, the subregions can be associated with key areas delineated on a surface of the proximity sensor device, where each of the key areas overlaps with at least one of the plurality of subregions. In such devices the key areas are associated with particular input options by identifying the key area on the surface, and associating the input option with the appropriate marker and direction of the stroke.

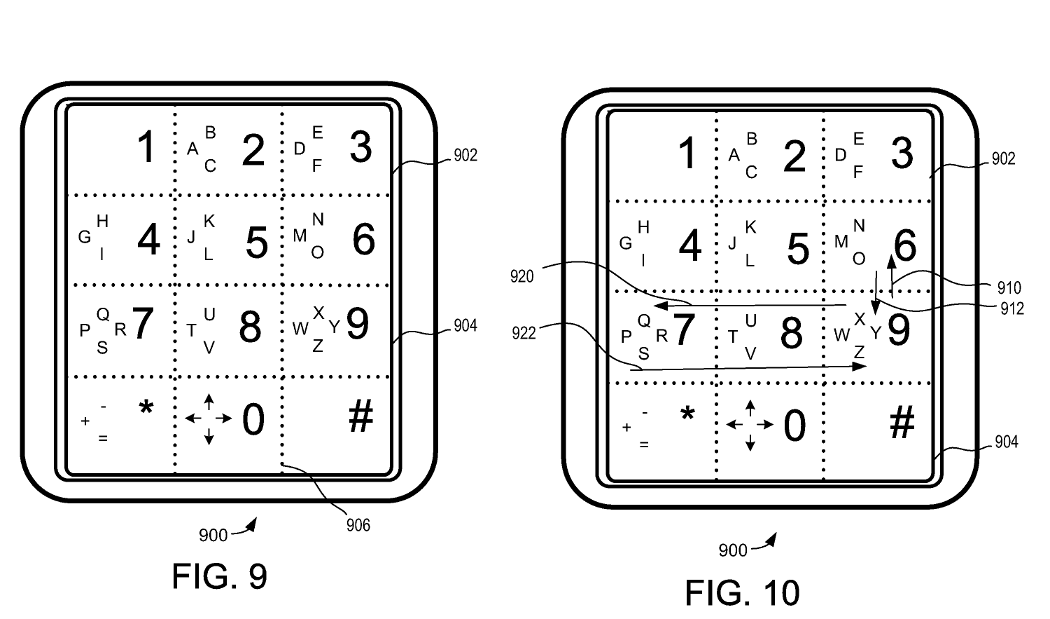

Turning now to FIGS. 9 and 10, another embodiment of a device 900 is illustrated. Device 900 again includes a proximity sensor device adapted to detect object motion in a sensing region 902. In this embodiment, a surface 904 that underlies the sensing region 902 is illustrated. Upon the surface 904 is delineated a plurality of key areas, with each of the key areas overlapping a corresponding subregion in the sensing region. In the illustrated embodiment, the key areas are delineated on the surface by dashed lines 906. Of course, this is just one example, and a variety of other indications can be used to delineate the key areas. For example, an oval or other shape in the approximate area of each subregion could delineate the corresponding key areas.

Also delineated on the surface 904 are identifiers of the various input options associated with the key areas. In the illustrated embodiment, a traditional phone input is delineated on the surface, with the key areas having a corresponding number, and a corresponding plurality of input options. In this case, the input options include text characters (A, B, C, etc), various symbols (+, −, =) and navigation elements (up, down, left and right). As such, the surface 904 is suitable for use on a mobile communication device such as mobile phone, tablet computer, or PDA.

The delineation of the key serves to identify the approximate location of the key area and its corresponding subregion to the user. Likewise, the delineation of the input options serves to identify the input options associated with the key areas. In this application, the term delineate is thus defined to include any identification of the key area on the surface and/or identification of input options on the surface. Delineation can thus include any representation, including printings, tracings, outlines, or any other symbol depicting or representing the key area and input options to the user. These delineations can be static displays, such as simple printing on the surface using any suitable technique. Alternatively, the delineations can be actively displayed by an electronic display screen when implemented in a touch screen.

FIG. 10 illustrates various strokes across the sensing region 902. Each of these strokes crosses one or more markers in the sensing region. Although not illustrated in FIG. 10, for purposes of these examples, the markers will be assumed to coincide roughly with the boundaries of the subregions, as was illustrated in FIGS. 5-8. In accordance with the embodiments of the invention, the proximity sensor is adapted to select an input option based on a marker crossed by the stroke and a direction of the stroke. The actual input option selected would of course depend on the association between input options, markers, and strokes, and in some cases, whether the last or first marker crossed is used.

For example, stroke 910 crosses from the key area for 9 to the key area for 6. As such, it would cross the marker between the two associated subregions, and an input option would be selected based on that marker and the direction of the stroke. Thus, the device could be implemented such that stroke 910 could result in an “X” input option being selected and the corresponding output produced. This is an example of an implementation where the selected input option corresponds to an input option that is delineated in the key area being crossed out of by the stroke.

Alternatively, the device could be implemented such that the stroke 910 could result in an “O” input option being selected. This is an example of an implementation where the selected input option corresponds to an input option that is delineated in the key area being crossed into by the stroke.

Likewise, stroke 912 crosses from the key area for 6 to the key area for 9. This stroke thus crosses the same marker as stroke 910, but in a different direction. When the device is implemented such that the selected input option corresponds to an input option delineated in a key are being crossed out of, this would again result in the “O” input option being selected. Alternatively, when the device is implemented to select an input option for a key area that is being crossed into, the stroke 912 would result in an “X” input option being selected.

These two examples show how the device can be configured to operate in a variety of different manners. The usability of these different embodiments many vary between applications. Furthermore, some users may prefer one over the other. Thus, in some embodiments, these various implementations could be made user configurable. In other embodiments, the device maker would specify the implementation.

As a next example, stroke 920 crosses from the key area 9, across the key area 8, and into the key area 7. As such, it would cross two markers between the three associated subregions, and an input option would be selected based on one of the markers crossed and the direction of the stroke. Likewise, stroke 922 crosses from the key area 7, across the key area 8 and into the key area 9.

As stated above, the device could be implemented to select an input option based on the last marker crossed, the first marker crossed, or somewhere in between. Likewise, as discussed above with reference to strokes 910 and 912, the input option selected could correspond to a key area crossed into or out when crossing the marker. This means that are many different possible implementations.

For example, assuming the device is implemented to select the last marker crossed, and is implemented to select an input option corresponding to a key area crossed into when that last marker is crossed, then stroke 920 would select input option “R” and stroke 922 would select input option “W”.

Conversely, assuming the device is implemented to select the first marker crossed, and is implemented to select an input option corresponding to a key area crossed into when that first marker is crossed, then stroke 922 would select input option “T”. In this case, stroke 920 would not select an option, as there is no input option for key area 8 in that direction. In such a case, the device may be configured to go to the next marker crossed, and in that case select input option “R”.

As another example, assuming the device is implemented to select the last marker crossed, and is implemented to select an input option corresponding to a key area crossed out of when that last marker is crossed, then stroke 920 would select input option “T”. Again, in this case, stroke 922 would not select an option, as there is no input option for key area 8 in that direction. In such a case, the device may be configured to use an earlier marker crossed, and in that case select input option “R”.

Conversely, assuming the device is implemented to select the first marker crossed, and is implemented to select an input option corresponding to a key area crossed out of when that first marker is crossed, then stroke 920 would select input option “W” and stroke 922 would select input option “R”.

Again, these are just various examples of how the device can be configured, and how the markers, key areas and input options associated to produce different outputs in response to strokes crossing the markers.

The proximity sensor device can further support other types of input in addition to marker-based input. For example, proximity sensor device 900 is implemented to enable user selection of input options from another set of input options. The other set of input options can be indicated appropriately, such as by the characters shown in relatively larger font (the numbers 0-9 as well as “*” and “#”) in FIGS. 9-10. The proximity sensor device can be configured to facilitate selection of input options from this set of input options in response to suitable user inputs that can be reliably distinguished from stroke crossing markers for selecting input options associated with the markers. For example, the proximity sensor device can be configured to select one of the set of input options in response to a gesture that meets a second set of criteria different from the criteria used to select input options associated with marker crossings. For example, one of the set of input options can be selected by user input can involving one or more touch inputs in the sensing region 902. Viable touch inputs include single touch gestures qualified with criteria involving duration, location, displacement, motion, speed, force, pressure, or any combination thereof. Viable touch inputs also include gestures involving two or more touches; each of the touches can be required to meet the same or different sets of criteria. As needed, these criteria can also help distinguish input for selecting these set of input options from strokes meant to cross markers and indicate input options associated with marker crossings. It is noted that, in some embodiments, some input options associated with marker crossings may also be selectable with non-marker crossing input. In these cases, the same input option may be a member of both a plurality of input options associated with a marker, and a set of input options unrelated to marker crossings.

As a specific example, the proximity sensor device 900 can be implemented with a second set of criteria such that the number “2” is selected in response to a single touch in the subregion associated with “2,” having a duration less than a maximum amount of time and an amount of motion less than a maximum amount of motion during that duration. As another specific example, the proximity sensor device 900 can be implemented such that the number “2” is selected in response to a single touch in the subregion associated with “2,” and having a duration greater than a minimum amount of time. The proximity sensor device 900 can be further implemented to check that the single touch has displacement of less than a reference amount of displacement, speed less than a maximum reference speed, or limited motion that does not bring the touch outside of the subregion associated with “2.”

The proximity sensor device 900 can also be implemented such that the number “2” is selected in response to an input having at least a defined amount of coupling. For example, the proximity sensor device 900 can include one or more mechanical buttons underneath capacitive sensors, and the number “2” would be selected in response to a touch input in the subregion associated with number “2” that has enough force to trigger the mechanical button(s). As another example, the proximity sensor device 900 can be implemented as a capacitive proximity device designed to function with human fingers. Such a proximity sensor device 900 can recognize selection of the number “2” based on the change in the sensed capacitance being greater than an amount typically associated with a finger touching surface 904, which often correlates with the user “pressing harder” on surface 904.

As discussed above, in addition to determining the selected input option based on the marker crossed, the device selects the input option based on the direction of the stroke. The direction of the stroke can be determined using many different techniques. For example, the direction of the stroke can be simply determined to be within a range of directions, and the actual direction need not be calculated with any precision. Thus, it can be implemented such that motion within a large range qualifies as a direction corresponding to a particular input option.

It should be noted that a typical stoke of object motion made by a user across the sensing region will have significant variation in direction, whether that is intentional on the part of the user or not. Thus, what is the direction of the stroke crossing the marker can established in many different ways. For example, the direction of a stroke can be determined at the instance it crosses the marker. As another example, the direction of a stroke can determined as an average direction, a predominant direction or the direction of vector between endpoints of the stroke.

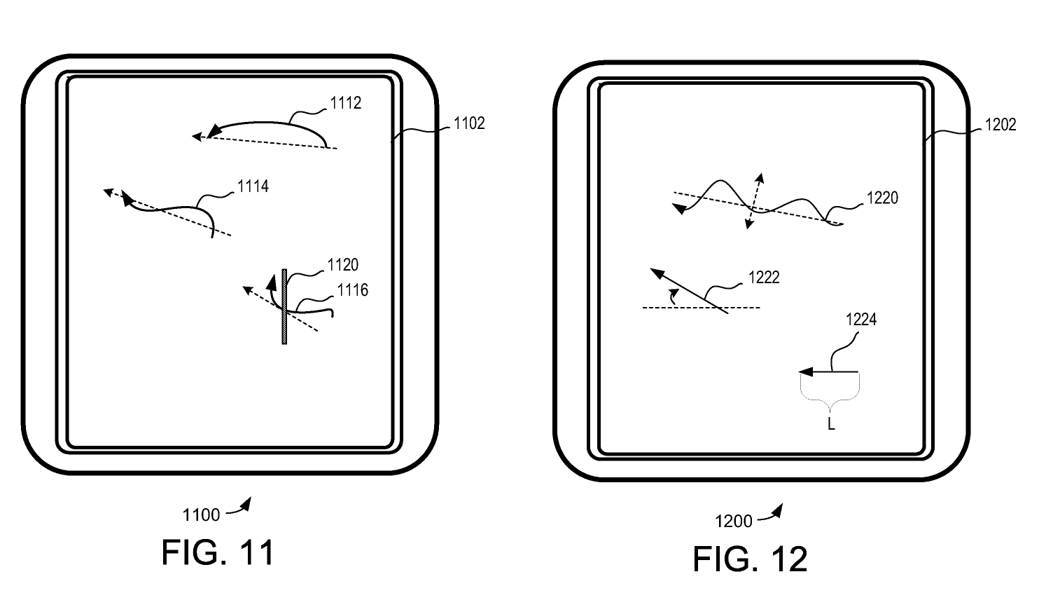

Turning now to FIG. 11, the device 1100 is illustrated with three exemplary strokes illustrated in a sensing region 1102. In each of the illustrated examples, the path of the stroke is illustrated with the arrowed line, while the determined direction is illustrated with the dotted arrow line. For stroke 1112, the direction of the stroke is determined as a vector between the endpoints of stroke. Such a vector could be calculated from the actual starting and ending positions of the stroke, or as a summation of incremental changes along the path of the stroke. For stroke 1114, the direction of the stoke is determined as an average of the direction along the path of the scope. Such an average could be calculated using any suitable technique, including a vector that minimizes the total deviation of the stroke 1114 from the direction. For stroke 1116, the direction of the stroke is determined about the instant at which it crosses the marker 1120; this can be determined with the two sensed locations closest in time to the instant of crossing, a set of sensed locations around the instant of crossing, a set of sensed locations immediately before or after the crossing, a weighted set of sensed locations covering some portion of the stroke history, and the like. Again, such a direction could be calculated using any suitable technique. Further, part or all of the stroke can be filtered or otherwise modified to ascertain better the intended input selection. Smoothing algorithms can be used as appropriate, outlying deviations can be disregarded in calculations, and the like.

Again, in using these techniques the direction need not be determined with any particular precision. Instead, it may be sufficient to determine if the direction of stroke is within a particular range of directions, and thus the actual direction need not be calculated.

In addition to stroke crossing a marker in the sensing region, the selection of an input option can be made subject to other criterion in a set of criteria. For example, other criterion in the set of criteria can include requirements for the length of the detected stroke, the angle of the detected stroke, the speed of the detected stroke, etc. In such an implementation, the selection of the input option would depend on the stroke meeting these other criteria. Turning now to FIG. 12, examples of various other criteria are illustrated. Stroke 1220 illustrates a stroke having significant deviation from a dominant direction of motion. Stroke 1222 shows a stroke having a significant deviation for a horizontal direction. Stroke 1224 shows a stroke having a length L. Again, these are three examples of criteria that can be used to determine selection of an input option.

For example, in one embodiment, if the length of detected stroke is not within a specified range of lengths then no selection of an input option will occur. This can be used to exclude strokes that are too short and/or too long. Rejecting strokes that are short can help distinguish from inadvertent object motion in the sensing region. Likewise, rejecting strokes that are too long can help avoid incorrect selection.

As another example, in one embodiment, if the angle of detected stroke is not within a specified range of angles then no selection of an input option will occur. This can be used to exclude strokes that are ambiguous as to the intended direction of the stroke. For example, by measuring the angle of the stroke where the marker is crossed and determining the deviation from horizontal or vertical, and rejecting strokes that are not within a specified range of either horizontal or vertical. Again, this can help distinguish from inadvertent object motion in the sensing region, and can help avoid incorrect selection.

As another example, in one embodiment, if stroke has a significant deviation from a dominant direction of motion then no selection of an input option will occur. Such a deviation occurs when the strokes wave back and forth, exhibiting curviness from the major axis of motion, rather than moving in a more constant direction. Again, this can be used to exclude strokes that are ambiguous as to the intended direction of the stroke. A variety of different techniques could be used to measure such a deviation from a dominant direction. For example, first derivatives of the stroke, taken along one or more defined axes, can be compared to that of the dominant direction. As another example, points along part or all of the stroke can be used to define local directions, and the deviation of these local directions from the dominant direction accumulated. Many such implementations would use adjacent points of data, others may use nearby but not adjacent points of data, and still others may use alternate ways to select the points of data. Further, the comparison can involve only the components of the local directions along a particular axis (e.g. only X or Y if the device is implemented with Cartesian coordinates). Alternatively, the comparison can involve multiple components of the local directions, but compared separately. As necessary, location data points along all or parts of the entire strokes can be recorded and processed. The location data can also be weighed as appropriate.

The embodiments of the present invention provide thus an electronic system and method that facilitates improved device usability. Specifically, the device and method provide improved user interface functionality by facilitating quick and easy data entry using proximity sensors with limited space. The electronic system includes a processing system and a sensor adapted to detect strokes in a sensing region. The device is adapted to provide user interface functionality by defining a plurality of markers in the sensing region and producing an output responsive to the sensor detecting a stroke that meets a set of criteria. The produced output corresponds to a selected option, and the option is selected from a plurality of options based on a marker crossed by the stroke and a direction of the stroke. By so defining a plurality of marker, and facilitating the selection of options based on a marker crossed by a stroke and the direction of the stroke, the electronic system facilitates fast and flexible user input in a limited space.

The embodiments and examples set forth herein were presented in order to best explain the present invention and its particular application and to thereby enable those skilled in the art to make and use the invention. However, those skilled in the art will recognize that the foregoing description and examples have been presented for the purposes of illustration and example only. The description as set forth is not intended to be exhaustive or to limit the invention to the precise form disclosed. Many modifications and variations are possible in light of the above teaching without departing from the spirit of the forthcoming claims.

1. An electronic system comprising:
a sensor adapted to detect strokes in a sensing region;
a processing system coupled to the sensor, the processing system configured to:
define a plurality of markers in the sensing region; and
responsive to the sensor detecting a stroke that meets all criteria in a set of criteria, wherein the set of criteria includes the stroke crossing at least one marker in the plurality of markers:
select at least one of a plurality of options based on:
a marker crossed by the stroke, and
a direction of the stroke, and
produce an output corresponding to the selected option.

2. The electronic system of claim 1 wherein the sensing region has a plurality of subregions, and wherein the processing system is configured to select at least one of the plurality of options based on a marker crossed by the stroke by:
selecting an option corresponding to a marker associated with the stroke exiting a subregion of the plurality of subregions.

3. The electronic system of claim 1 wherein the sensing region has a plurality of subregions, and wherein the processing system is configured to select at least one of the plurality of options based on a marker crossed by the stroke by:
selecting an option corresponding to a marker associated with the stroke entering a subregion of the plurality of subregions.

4. The electronic system of claim 1 wherein the processing system is configured to select at least one of the plurality of options based on a marker crossed by the stroke by:
selecting an option corresponding to a first marker crossed by the stroke.

5. The electronic system of claim 1 wherein the processing system is configured to select at least one of the plurality of options based on a marker crossed by the stroke by:
selecting an option corresponding to a last marker crossed by the stroke.

6. The electronic system of claim 1 wherein the sensing region has a plurality of subregions, and further comprising:
a surface, the surface including a plurality of key areas delineated on the surface, wherein each of the plurality of key areas overlaps with at least one of the plurality of subregions.

7. The electronic system of claim 1 wherein the sensing region has subregions, and wherein the plurality of markers is aligned with boundaries of the subregions.

8. The electronic system of claim 1 wherein the set of criteria further includes the stroke having a length within a range of lengths.

9. The electronic system of claim 1 wherein the set of criteria further includes the stroke having an angle within a range of angles.

10. The electronic system of claim 1 wherein the set of criteria further includes the stroke having at least one of a speed of the stroke in a range of speeds and a change in capacitive coupling caused by an object providing the stroke in a range of changes in capacitive coupling.

11. The electronic system of claim 1 wherein the set of criteria further includes the stroke having a deviation from a dominant direction within a range of deviations.

12. The electronic system of claim 1 wherein the processing system is configured to select at least one of the plurality of options based on a direction of the stroke by:
selecting an option corresponding to at least one of a direction of the stroke when crossing the marker crossed and a direction of a vector from a beginning to an end of the stroke.

13. The electronic system of claim 1 wherein the sensing region includes a plurality of subregions associated with a second plurality of input options, and wherein the processing system is further configured to:
select at least one of the second plurality of input options responsive to the sensor detecting a user input meeting a second set of criteria, wherein the second set of criteria includes the stroke having amount of motion less than a maximum amount of motion.

14. A method for entering data on a proximity sensor device, the method comprising:
defining a plurality of markers in a sensing region of the proximity sensor device;
detecting strokes in the sensing region;
responsive to detection of a stroke meeting a set of criteria, the set of criteria including the stroke crossing at least one marker in the plurality of markers:
selecting at least one of a plurality of options based on:
a marker crossed by the stroke, and
a direction of the stroke, and
generating a response corresponding to the selected option.

15. The method of claim 14 wherein the sensing region has a plurality of subregions, and wherein selecting at least one of the plurality of options based on a marker crossed by the stroke comprises:
selecting an option corresponding to a marker associated with the stroke exiting a subregion of the plurality of subregions.

16. The method of claim 14 wherein the sensing region has a plurality of subregions, and wherein selecting at least one of the plurality of options based on a marker crossed by the stroke comprises:
selecting an option corresponding to a marker associated with the stroke entering a subregion of the plurality of subregions.

17. The method of claim 14 wherein selecting at least one of the plurality of options based on a marker crossed by the stroke comprises:
selecting an option corresponding to a first marker crossed by the stroke.

18. The method of claim 14 wherein selecting at least one of the plurality of options based on a marker crossed by the stroke comprises:
selecting an option corresponding to a last marker crossed by the stroke.

19. The method of claim 14 wherein the sensing region has a plurality of subregions, wherein the proximity sensor device has a surface including a plurality of key areas delineated on the surface, wherein each of the plurality of key areas overlaps with at least one of the plurality of subregions.

20. The method of claim 14 wherein the sensing region has subregions, and the plurality of markers are aligned with boundaries of the subregions.

21. The method of claim 14 wherein the set of criteria further includes the stroke having a length within a range of lengths.

22. The method of claim 14 wherein the set of criteria further includes the stroke having an angle within a range of angles.

23. The method of claim 14 wherein the set of criteria further includes at least one of a speed of the stroke being in a range of speeds and a change in capacitive coupling that an object providing the stroke causes being in a range of changes in capacitive coupling.

24. The method of claim 14 wherein the set of criteria further includes the stroke having a deviation from a dominant direction within a range of deviation.

25. The method of claim 14 wherein selecting at least one of the plurality of options based on a direction of the stroke comprises:
selecting an option corresponding to one of a direction of the stroke when crossing the marker crossed and a direction of a vector from a beginning to an end of the stroke.

26. A program product comprising:
a) a proximity sensor program, the proximity sensor program adapted define a plurality of markers in a sensing region of a sensor, the proximity sensor program further adapted to:
responsive to the sensor detecting a stroke that meets all criteria in a set of criteria, wherein the set of criteria includes the stroke crossing at least one marker in the plurality of markers:
select at least one of a plurality of options based on:
a marker crossed by the stroke, and
a direction of the stroke, and
produce an output corresponding to the selected option; and
b) computer-readable media bearing said proximity sensor program.
